(19) United States
(12) Patent Application Publication
(10) Pub. No.: US 2014/0063063 A1
(43) Pub. Date: Mar. 6, 2014

(54) Spatial Calibration System for Augmented Reality Display

(71) Applicants: Christopher G. Scott, Commerce City, CO (US); Adrienne J. Scott, Commerce City, CO (US); John R. Crafton, Siloam Springs, AR (US)

(72) Inventors: Christopher G. Scott, Commerce City, CO (US); Adrienne J. Scott, Commerce City, CO (US); John R. Crafton, Siloam Springs, AR (US)

(21) Appl. No.: 14/015,178

(22) Filed: Aug. 30, 2013

Related U.S. Application Data
(60) Provisional application No. 61/695,021, filed on Aug. 30, 2012.

(51) Int. Cl. G06T 11/60

(52) U.S. Cl. CPC G06T 11/60
USPC 345/633

(57) ABSTRACT

Systems and methods are described to allow a user of a computing device to augment a captured image of a design space, such as a photograph or a video of an interior room, with an image of a design element, such as a photograph. The disclosure provides systems and methods that enable users of computing devices to capture images from the design space, calibrate the size of a virtual image of a design element to the captured image of the design space, overlay the calibrated virtual image onto the captured image, and adjust the virtual image.

### RELATED APPLICATION

This application claims the benefit of U.S. Provisional Application No. 61/695,021, filed Aug. 30, 2012, which application is hereby incorporated by reference.

### INTRODUCTION

Decorating the home can be very stressful. For instance, individuals frequently experience frustration by not being able to actually visualize how a design element, such as a photograph, decoration, piece of furniture, or new architectural feature, will look in an existing space.

Moreover, the cost and effort to install the design element can be considerable. Consider photographs and decorations. Mounting photographs and decorations on a wall typically leaves a permanent mark on the wall. Thus, individuals may be fearful of mounting an image and/or arrangement on a wall that they are not entirely sure will satisfy their tastes. This may complicate the selection of decorations, images, sizes, layouts, and/or arrangements for display.

Though computer programs may help alleviate these problems, the current technology fails in certain respects. For example, the current technology lacks the ability to capture an image of the design space from within the software without relying on peripheral devices and modules to import the image. Further, current technology utilizes cumbersome calibration techniques. Moreover, the current software tools are not typically adapted for use on a mobile device, thereby inhibiting their use by architects, photographers, and interior decorators who travel to customers. Additionally, the current technology is often not adapted to enable the instantaneous sharing of created collections via email, social media, or the like. Furthermore, purchasing the photographs is not easily facilitated with current technology.

It is with respect to these and other considerations that embodiments have been made. Also, although relatively specific problems have been discussed, it should be understood that the embodiments should not be limited to solving the specific problems identified in the introduction.

### SUMMARY

Systems and methods are described to allow a user of a computing device to augment a captured image of a design space, such as a photograph or a video of an interior room, with an image of a design element, such as a photograph. The disclosure provides systems and methods that enable users of computing devices to capture images from the design space, calibrate the size of a virtual image of a design element to the captured image of the design space, overlay the calibrated virtual image onto the captured image, and adjust the virtual image.

In an embodiment of the present disclosure, a computer implemented method for displaying a design element on a design space is performed. The method receives a captured image, and the captured image includes a calibration object and an environmental object. The method also identifies the calibration object, and the calibration object has at least one identifiable dimension. Additionally, the method calculates a calibration metric, and the calculation uses the at least one identifiable dimension of the calibration object. The method also receives a virtual image, and the virtual image represents a real-world design element. The method applies the calibration metric to the virtual image to form a calibrated virtual image, and the method overlays the calibrated virtual image onto the captured image to form an overlaid captured image.

In another embodiment a computer-readable storage device is used. The computer-readable device storing computer-executable has instructions for performing a method of exchanging information in a collaborative networked environment. The method includes receiving a captured image, wherein the captured image includes a calibration object. The method also includes identifying the calibration object, wherein the calibration object has at least one identifiable dimension. Additionally, the method includes calculating a calibration metric, wherein the calculation uses the at least one identifiable dimension of the calibration object. The method also includes receiving a template map, and receiving a virtual image. The virtual image represents a real-world design element. Further, the method includes applying the calibration metric to the virtual image to form a calibrated virtual image, arranging the calibrated virtual image in accordance with the template map, overlaying the calibrated virtual image onto the captured image to form an overlaid captured image, and displaying the overlaid captured image.

In another embodiment a computer system for displaying a design element on a design space is used. The system includes an input module, wherein the input module receives a captured image and identifies a calibration object within the captured image. The system also includes a calibration module, wherein the calibration module calibrates one or more virtual images for overlay on the captured image, and further wherein the calibration module uses the calibration object to calculate a calibration metric. Additionally, the system includes a template module, wherein the template module maps the one or more virtual images into a template map, and the system includes a display module, wherein the display module displays a calibrated virtual image onto a captured image to form an overlaid image, the calibrated virtual image having been created by calibrating the size of a virtual image using the calibration metric.

### BRIEF DESCRIPTION OF THE DRAWINGS

Non-limiting and non-exhaustive embodiments are described with reference to the following Figures in which:

FIG. 1 illustrates an embodiment of a computing environment in which the present disclosure may be implemented;

FIG. 2 illustrates a graphical user interface displaying a captured image on a mobile computing device;

FIG. 3 illustrates an embodiment of a template map;

FIG. 4 a graphical user interface displaying calibrated virtual images overlaid onto a captured image;

FIG. 5 illustrates an embodiment of a networked system in which embodiments disclosed herein may be performed;

FIG. 6 illustrates a method of displaying calibrated virtual images on a captured image; and

FIG. 7 illustrates a computing device 700 in which the present disclosure may be performed.

### DETAILED DESCRIPTION

Various embodiments are described more fully below with reference to the accompanying drawings, which form a part hereof, and which show specific exemplary embodiments. However, embodiments may be implemented in many different forms and should not be construed as limited to the embodiments set forth herein; rather, these embodiments are provided so that this disclosure will be thorough and complete, and will fully convey the scope of the embodiments to those skilled in the art. Embodiments may be practiced as methods, systems, or devices. Accordingly, embodiments may take the form of a hardware implementation, an entirely software implementation, or an implementation combining software and hardware aspects. The following detailed description is, therefore, not to be taken in a limiting sense.

Additionally, although parts of the disclosure discuss embodiments in the context of displaying virtual images of photographs on interior room walls, it should be noted that the technology is not so limited and can be used for displaying any virtual image of a design element (e.g., a decoration, a piece of furniture, a new architectural feature, etc.) on a captured image (e.g., an exterior wall, a floor plan, an office, etc.).

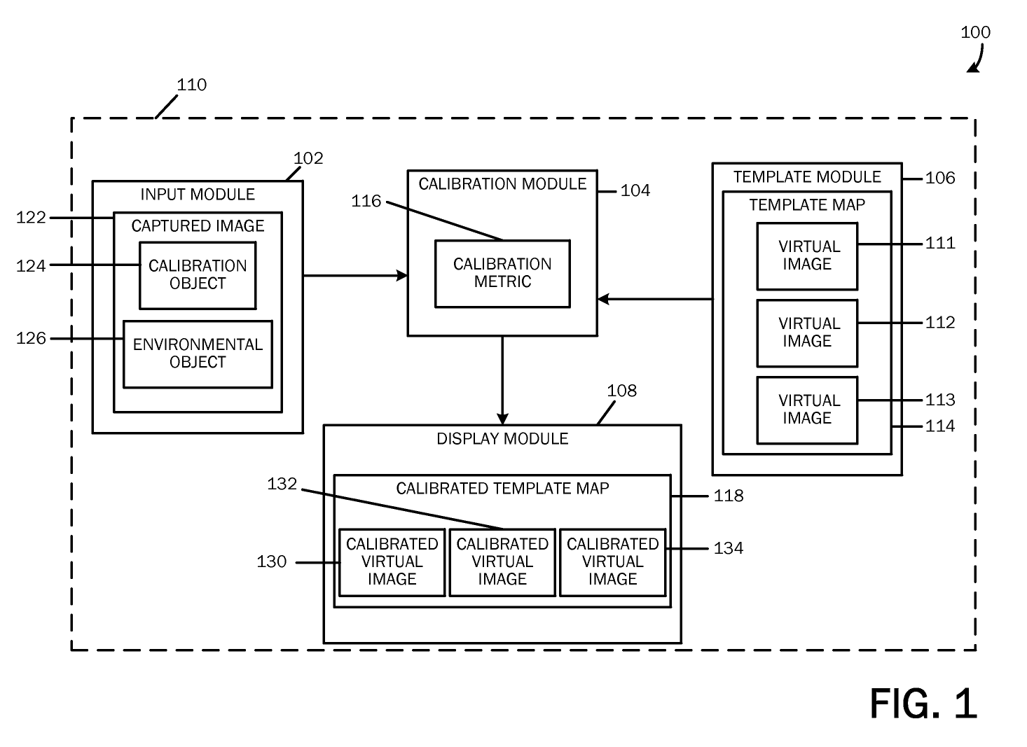

FIG. 1 illustrates an embodiment of a computing environment 100 in which the present disclosure may be implemented. As illustrated, the computing environment 100 includes an input module 102, a calibration module 104, a template module 106, and a display module 108. In an embodiment, each of these modules is housed on computing platform 110. In other embodiments, multiple computing platforms may be used synergistically.

The input module receives a captured image and identifies a calibration object. The captured image 122 may have been captured using a mobile computing device camera. Alternatively, an image previously stored in a computing device may be used as a captured image.

A captured image is either a video or photograph of a design space. Additionally, a captured image is an image that represents a real-world physical space, such as a bedroom, office, kitchen, garage, exterior wall, floor plan, etc. Any perspective may be used for the captured image such as one point, two point, three-point, birds-eye, etc.

A calibration object is a computerized representation of a real-world item (i.e., a reference item) present in the captured image with at least one identifiable dimension. In an embodiment, the calibration object 124 is used by the calibration module 104 to calibrate the physical dimensions of virtual image 111, 112, and 113. One or more physical dimensions of the calibration object 124 are used by the calibration module 104. For example, the calibration object 124 may represent the reference item of a standard letter size piece of paper with dimensions of 215.9 mm×279.4 mm (8.5 in×11 in). The piece of paper may have been placed in the design space for purposes of creating a calibration object 124 in the captured image 122. Other reference items may be used to created calibration objects. A non-exhaustive list of example reference items include: other sized pieces of paper with at least one known dimension; commonly sized objects such as queen-sized (or other) beds, standard refrigerators, standard dishwashers, walls of standard heights, and common window sizes, etc.; and previously measured custom reference items such as a particular rope, paper, or another object with at least one known dimension.

An environmental object is a computerized representation of a real-world item with dimensions that may or may not be known. For example, an environmental object 126 may be an image of a nightstand, a lamp, a desk, a bed, a car, a pillow, etc., where the objects do not have a dimension that is used by the calibration module 104.

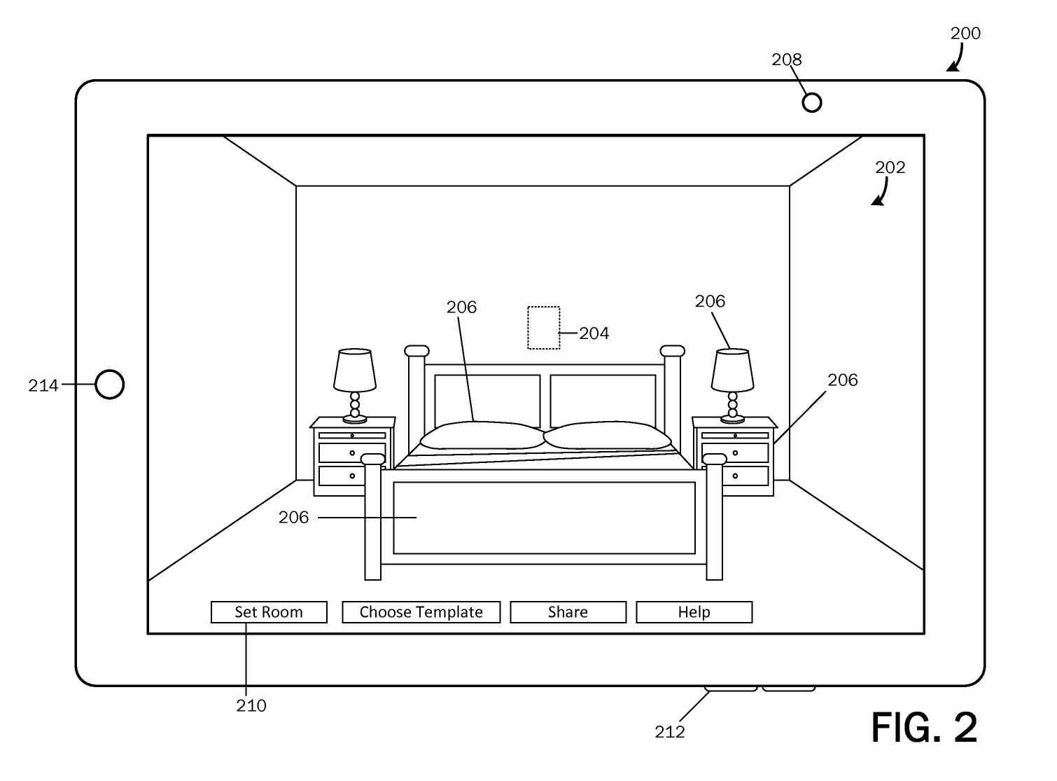

In an embodiment, the input module 102 determines which object is the calibration object 124. Determination of the calibration object 124 may be performed by detecting user input. For example, the user may identify the calibration object 124 by using a graphical user interface. In an alternative embodiment, the input module 102 automatically determines the calibration object 124. Techniques for identifying calibration objects are discussed more with reference to FIG. 2 below.

In an alternative embodiment, the input module 102 automatically determines the calibration object 124. For example, the input module 102 may automatically identify objects that may potentially be the calibration object 124. The input module 102 may identify the rectangular image as having dimensions l×w. Where the reference item is letter size piece of paper, the input module 102 may be programmed to identify objects that represent a letter-sized piece of paper within the captured image 122. One identification technique is as follows: the input module 102 may segment the captured image 122 into a grid. The input module 102 may then detect color changes in adjacent grids (or within sub-grids of grids) to determine a shape. This may cause the input module to identify a substantially rectangular image. In another embodiment, a characteristic of the image may be used, such as particular physical characteristic (e.g., three holes on a side of a paper) or marking such as a barcode or QR code. The input module may then determine that this image is the calibration object 104. The input module 102 may then identify, by accessing a database for example or other memory, the real world size of at least one dimension of the reference item associated with the calibration object 104. In another embodiment the real-world size of the item is input by the user. Other object detection techniques may be used as known in the art. Additionally, the input module 102 may then highlight the portion identified as the potential calibration object for user confirmation. In alternative embodiments, the input module 102 does not use user input for confirmation. For example, the identification of a predetermined shape and color change may confirm that the object is the calibration object 124.

The input module 102 then passes information regarding the captured image 122 to the calibration module 104. The calibration module calibrates a virtual image to appropriate (e.g., scaled) dimensions for overlay on a captured image using a calibration object. A virtual image is any image that represents a real-world physical design element. For example, a virtual image may be: a blank canvas, a ceramic tile, a photograph, a decoration, a window treatment, or a placeholder object. The placeholder object is later modified with particular attributes using the display module as discussed below. The information that is received by the calibration module 104 includes the calibration object 124. Additionally, the calibration module 104 receives virtual images 111, 112, and 113 from the template module 106. In an embodiment, the calibration module also receives a template map 114. The calibration module 104 uses calibration object 124 to determine the appropriate image size of virtual images 111, 112, and 113 received from a template module 106 (i.e., the calibration module 104 calibrates the virtual images 111, 112, and 113).

The calibration module 104 may calibrate the virtual image using a variety of techniques. One technique is as follows: one dimension of the calibration object 124 is identified as a calibration metric 116. A calibration object 124 may have dimensions w×l. For example, the length of the image of a letter size paper may be used as a calibration metric 116. As an example, the letter size piece of paper is oriented in such a way that the runs horizontal, and the length runs vertical. The calibration module 104 determines the as displayed image size of the calibration object 124. For example, the long side of the paper may be displayed with a size of 38.1 mm (1.5 in). The calibration module 104 then determines the ratio between the reference item represented by the calibration object 124 and the display size of the calibration object 124. This may be accomplished by dividing the displayed length of the calibration object 124 by the actual length of reference item. For example, this ratio may be 0.136. It will also be noted for purposes of the present disclosure, that multiple calibration ratios may be calculated based on the calibration object 124. For example, in addition to the ratio calculated by the length dimension of the calibration object 124, a calibration ratio associated with the width dimension may also be calculated.

In an embodiment, the virtual images 111, 112, and 113 will then be sized appropriately using the ratio. For example, the virtual image 111 may be a representation of an 8 in×10 in blank canvas. The calibration module 104 applies the ratio to the virtual image 111 to create a calibrated virtual image 120. In this example, the calibrated virtual image 120 will have a resulting display size of 27.4 mm×34.5 mm (1.08 in×1.36 in). In alternative embodiments, more than one dimension of calibration object 124 is used. This may be used to change the angles and dimensions of virtual images 111, 112, and 113 to account for a captured image 122 captured at various perspectives. Additionally, the calibration module 104 may calibrate template map 114 to create a calibrated template map 118 in a similar fashion. In an embodiment, the calibration module 104 passes information regarding the calibrated virtual images 130, 132, and 134, the captured image 122, the calibration metric 116, and the calibrated template map 118 to the display module 108.

A template module is a module that arranges virtual images into template maps. A template map is a fixed arrangement of one or more virtual images. For example, the template map 114 may be used to arrange a collection of virtual images 111, 112, and 113.

The template map 114 may be created through a user interface. For example, a user may desire to create an arrangement of blank canvases for purposes of displaying photographs or other artistic media. In an embodiment, a user may interact with a graphical user interface to build a template map 114 using a template module. In an embodiment, the template module 106 provides a graphical user interface where a user may select virtual images 111, 112, and 113 and arrange those images into a set pattern. Virtual images 111, 112, and 113 may be resized. Additionally, virtual images 111, 112, and 113 may have other design features added or removed. For example, in an embodiment where virtual images 111, 112, and 113 are photographs, frames or mats may be added or removed. Such interaction may result in the creation of a template map 114. The user may then save the template map 114 for further use. This template map 114, along with the virtual images 111, 112, and 113, may then be sent to the calibration module 104 for calibration as discussed above.

The display module 108 displays a calibrated virtual image onto a captured image. Additionally, the display module may change the appearance of a calibrated virtual image. For example, the user may add features such as framing options, mat finish, etc. to the calibrated virtual image where the calibrated virtual image is a photo.

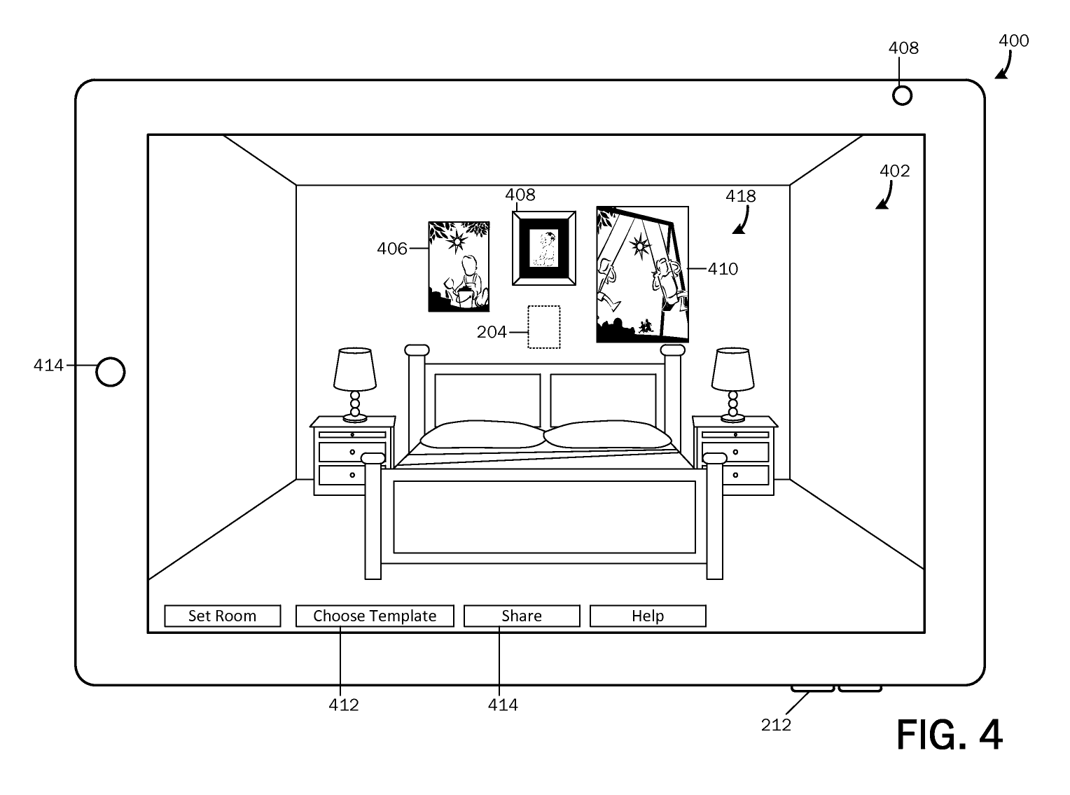

In an embodiment, the display module 108 displays a calibrated template map 118 incorporating the calibrated images 130, 132, and 134 on the captured image 118. In an embodiment, the display module 108 uses a graphical user interface to allow a user to interact with the calibrated template map 118 and the calibrated virtual images 130, 132, and 134. Such interaction is discussed more with reference to FIG. 4.

FIG. 2 illustrates a graphical user interface displaying a captured image 202 on a mobile computing device 200. As illustrated, the captured image 202 is of an interior bedroom. The captured image 202 includes calibration object 204 and one or more environmental objects 206 including: a night-stand, a lamp, a bed (of unidentified size), and a pillow.

A user may select the captured image 202 through the use of a graphical user interface. For example, a user may select a captured image 202 by selecting the Set Room image icon 210 as illustrated in FIG. 2. Selecting the Set Room image icon 210 may result in a menu appearing where a user can choose various file paths in which an image may be stored. The captured image 202 will then be displayed on an output display of a computing device, such as mobile computing device 200. In another embodiment, selecting the set room image icon 210 enables functionality to capture an image using a camera located on a mobile computing device 200, such as camera 208. In an alternative embodiment, the captured image 202 is continuously updated via the camera 208 housed on the mobile computing device 200. As illustrated, the camera 208 is on the same side of the mobile device as the display screen. In other embodiments of a mobile computing device, the camera 208 is on the opposite side.

FIG. 2 also illustrates a graphical user interface that may be used to allow a user to identify a calibration object 204. Identification may occur by a user drawing a box around the calibration object 204. Such drawing may be accomplished via a touch screen. One touch technique that may be implanted is as follows: the user touches one corner of the calibration object 204 moves along the input device until the user reaches the diagonal corner. In an other embodiment a rectangle is displayed on the display of computing device 200. The rectangle has a predefined aspect ratio that corresponds to a predefined calibration object 204. In other embodiments, a mouse and/or stylus may be used. Additional control of the mobile computing device 200 may occur through input buttons 212 and 214.

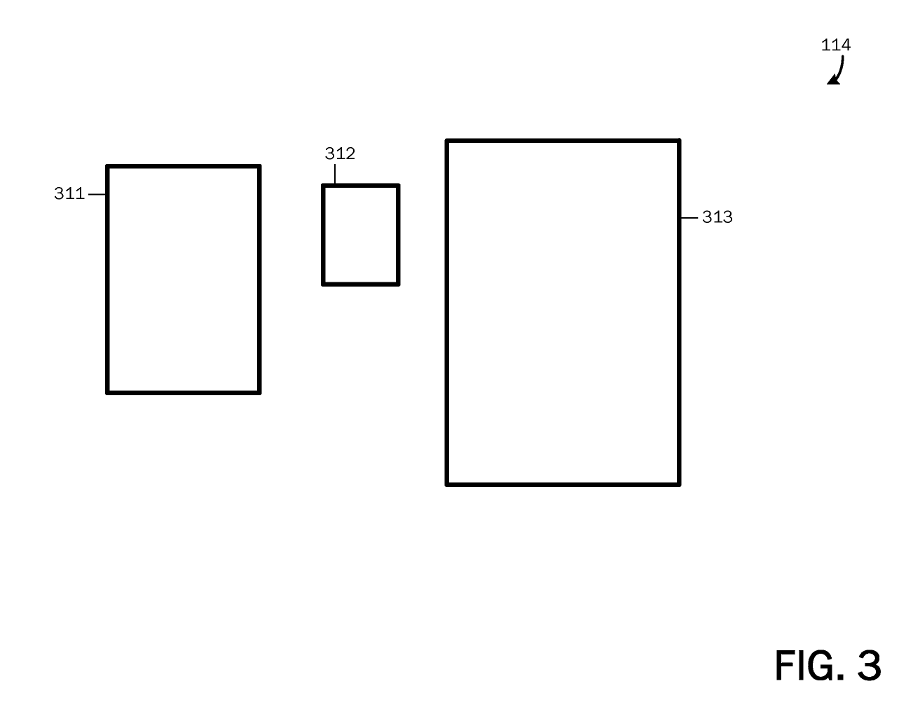

FIG. 3 illustrates an embodiment of a template map 114. As illustrated, the virtual image 311 represents a canvas with dimensions of 406.4 mm×609.6 mm (16 in×24 in), the virtual image 312 represents a canvas with dimensions of 203.2 mm×254 mm (8 in×10 in), and the virtual image 313 represents a canvas with dimensions of 609.6 mm×mm (24 in×36 in). In other embodiments, the template map may be an arrangement of windows and frames, ceramic tile patterns, etc. Template maps may be used by a user to save preferred arrangements of virtual images for quick importation and overlay on captured images.

FIG. 4 illustrates a graphical user interface of computing device 400 displaying calibrated images 406, 408, and 410 overlaid onto a captured image 402. The calibrated images 406, 408, and 410 are arranged for display using a calibrated template map 418.

A user may interact with the graphical user interface of mobile computing device 400 to change the position of the calibrated template map 418 along with its corresponding calibrated images 406, 408, and 410 within the captured image 402. Such movement of the image may occur through the use of a touch screen. For example, the user may touch an area of a touch screen associated with the calibrated template map 418. This selects the calibrated template map 418. The user may than drag a finger across the screen to adjust the location of the calibrated template map 418 and the associated calibrated virtual images 406, 408, and 410. In an embodiment, a two finger touch is used to move the position of the template map 418. In an embodiment, the display module provides guidelines to identify the center of the captured image In an embodiment, a template map 418 may be rotated. When the template map 418 is moved about the captured image, the relative positions of calibrated virtual images 406, 408, and 410 does not change within the calibrated template map.

In an embodiment, a graphical user interface is used to interact with the display to change the calibrated template map 418. This may occur by interacting with a “Choose Template” button 412. In an embodiment, a one-finger swipe movement facilitates scrolling between available calibrated template maps. In one embodiment, a user interacts with graphic image icon Choose Template 412 prior to performing the one-finger swipe to scroll between various calibrated template maps 418. In another embodiment, the template maps 418 are grouped. Such grouping may occur by a user determining that certain template maps represent design elements in a particular arrange that are of a similar style. A change in a calibrated template map may change the number of virtual images or the relative position of those virtual images.

Additionally, in an embodiment, a graphical user interface is used to change the calibrated virtual images 406, 408, and 410. For example, FIG. 4 illustrates graphical user interface with a graphic image icon Choose Template 412. In an embodiment touching the Choose Template 412 brings up a menu where a user may select other calibrated virtual images from which to choose. Such a menu may be a pop-up menu. For example, the photographs displayed by the calibrated virtual images 406, 408, and 410 may be changed to different photographs.

Touching Choose Template 412 may alter other properties of the calibrated images. For example, as illustrated, the calibrated virtual images 406, 408, and 410 represent photographs that may be framed. The user may desire to see how the calibrated virtual images 406, 408, and 410 would appear like if the photographs were framed. The user may select a framing option by interacting with a menu that is brought up by touching Choose Template 412. A framing option will then be applied to the photograph and the virtual calibrated image 406, 408, and 410 will be adjusted accordingly.

Additionally, the display module allows one to share the calibrated virtual image overlaid on a captured image. For example, clicking or interacting with the image icon Share 414 will allow one to share the calibrated images 406, 408, and 410 arranged in template 418 overlaid on captured image 402. Such sharing may occur through email, social media, or other file sharing techniques. The sharing may be directed to a vendor of professional services to facilitate the production of a real world objects corresponding to the calibrated virtual image. For example, a photographer may mat, frame, and deliver the photographs corresponding to the calibrated images 406, 408, and 410 that were sent as a result of user interaction with the image icon Share 414. The graphical user interface of computing device 400 may also facilitate immediate purchase of such finished photographs.

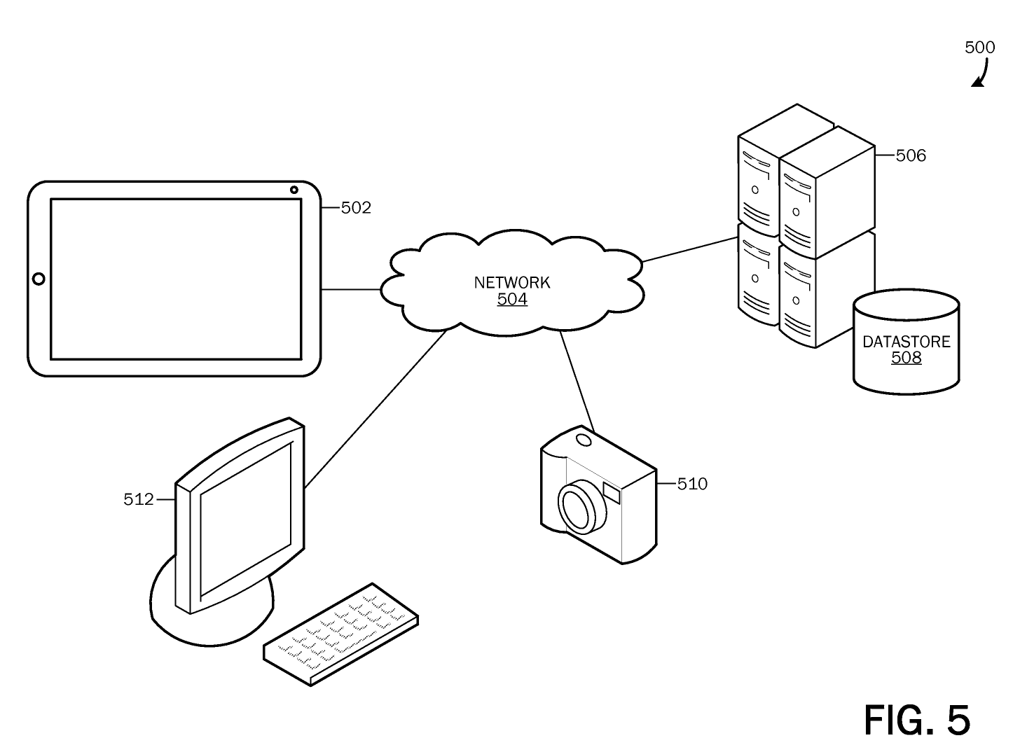

FIG. 5 illustrates an embodiment of a networked system 500 in which embodiments disclosed herein may be performed. As illustrated, a mobile computing device 502 is connected to a computing device 512, an image capture device 510, and a server 506. The server 506 is connected to a database 508.

In an embodiment, the mobile computing device 502 instantiates an input module, a calibration module, a template module, and a display module similar to those described with reference to FIG. 1. The mobile computing device 502 may access template maps and virtual images from local memory or storage devices. In other embodiments, the mobile computing device 502 accesses template maps and virtual images by requesting such information from a server 506.

The server 506 may access a database 508 to retrieve information such as template maps and virtual images. Virtual images and template maps may be sent to a mobile computing device via a network 504.

An image capture device 510 may be used to capture virtual images. For example, a photographer may use a networked camera to snap photographs of a family. These photographs may be uploaded to the server 506 for storage in the database 508 as virtual images. In another embodiment, the image capture device 510 is used to capture images of windows, tiles, furniture, or other real world images. An image capture device 510 may be a 3-D image capture device, such as a 3-D camera.

A computing device 512 may be used to create template maps. The template maps may be created by instantiating a template module on the computing device 512. Additionally, the computing device 512 may store virtual images. For example, a photographer may upload previously taken photographs into the computing device 512. The computing device may directly share template maps and virtual images with the mobile computing device 512. In an alternative embodiment, the computing device 512 sends template maps and virtual images to a remote database, such as database 508.

A network 504 facilitates communication between mobile computing device 502, computing device 512, image capture device 510, and server 506. There are numerous types of networks that one could employ to allow devices to communicate with each other. Communication may occur through the use of wireless and/or other technologies. For example, the network 504 could be the Internet or a local area network (“LAN”). In a particular embodiment, the network 504 may be a tightly coupled business network where the server system is relatively “dedicated” to a small number of computers in a LAN environment.

The server 506 handles requests of one or more devices, such as mobile computing device 502, image capture device 510, and computing device 512. In an embodiment, the server 506 is a computer, or series of computers, linked together that serves the requests of other computer programs, such as computer programs running on mobile computing device 502 and computing device 512. The server 506 also typically includes physical hardware such as one or more computer processors, memory, one or more hard drives, communication connections, and input/output devices.

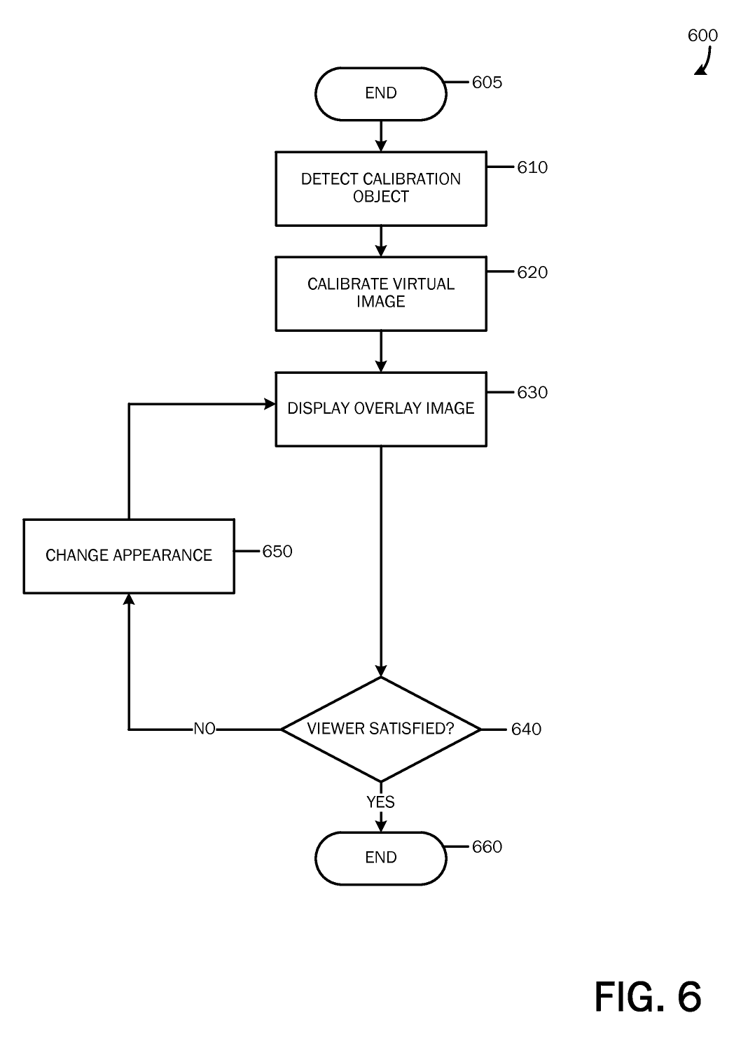

FIG. 6 illustrates a method 600 of displaying calibrated virtual images on a captured image. Method 600 begins at start operation 605 and proceeds to detect calibration object operation 610. In detect calibration object operation 610, an input module receives a captured imaged. The captured image may be any image that a user desires to augment with a virtual image. The input module then identifies a calibration object within the captured image. Such identification may occur as described with reference to FIG. 1.

In an embodiment, the method 600 then proceeds to calibrate virtual image operation 620. In calibrate virtual image operation 620, a calibration module receives information related to the captured image. This information includes a calibration object. In an embodiment, the calibration module then calculates a calibration metric to be used to calibrate virtual images appropriately. For example, scaling may be used. Scaling a virtual image includes adjusting the size of the virtual image so that the physical object represented by the virtual image is a scaled size when the virtual image is overlaid on the captured image. The calculation of a calibration metric may be performed in a manner similar to that discussed with reference to FIG. 1. In alternative embodiments, a template map is also calibrated by the calibration module.

As illustrated, the method then proceeds to display overlay image operation 630. In display overlay image operation 630 a display module overlays the calibrated virtual image onto a captured image. This overlay is displayed onto a computing device to form an overlaid captured image.

The method 600 may then proceed to viewer satisfied determination 640. Determination that a viewer is satisfied may occur in several ways. In an embodiment, a display module instantiated on a computing device may have determined that a user is satisfied with the image on account that the computing device has received no user input for a preset time. In alternative embodiments, the display module receives input that indicates that the user is satisfied with the overlaid captured image. For example, a user may touch a save icon displayed on a computing device.

If the user is not satisfied, the method 600 proceeds to change appearance operation 650. The appearance of the overlaid captured image can be changed by moving the calibrated virtual image around the captured image. Additionally, the properties of the calibrated virtual image may be changed by augmentation. Such augmentation may include changing the photo represented by the virtual image, or adding a frame. Additionally, in embodiments where a template map is overlaid on a captured image, the template map may be changed. Changing calibrated virtual images and template maps is discussed with reference to FIGS. 1 and 4 above. The method 600 ends at operation 660.

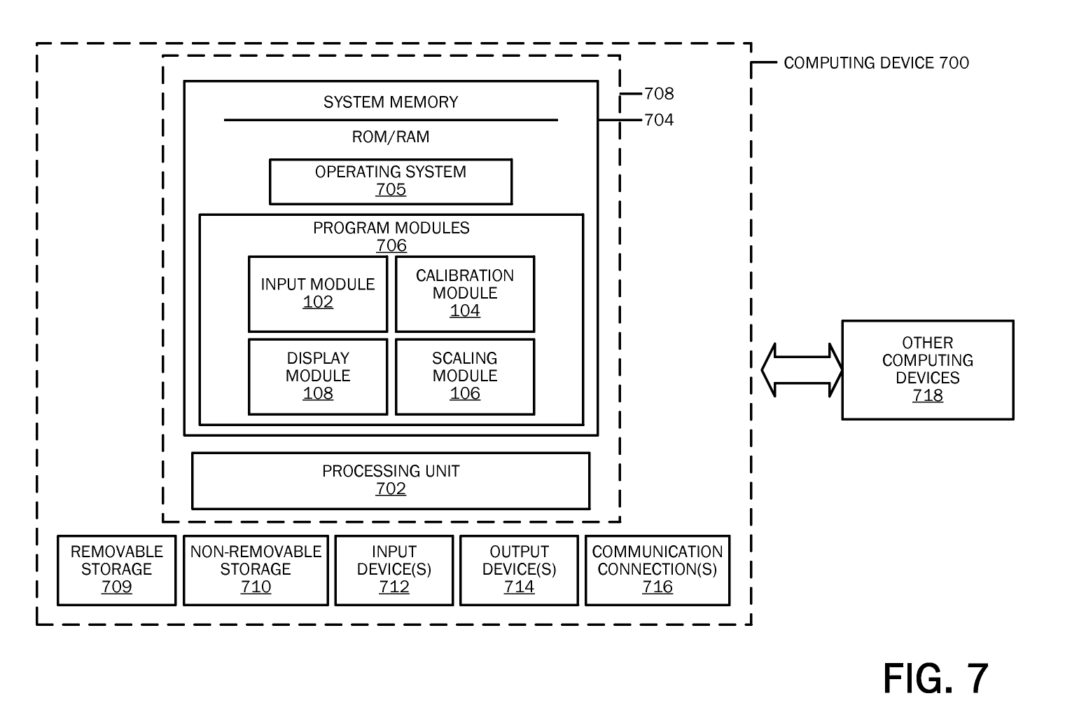

Embodiments of the invention may be implemented via local and remote computing and data storage systems. Such memory storage and processing units may be implemented in a computing device, such as computing device 700 of FIG. 7. Any suitable combination of hardware, software, or firmware may be used to implement the memory storage and processing unit. For example, the memory storage and processing unit may be implemented with computing device 700 or any other computing devices 718, in combination with computing device 700, wherein functionality may be brought together over a network in a distributed computing environment, for example, an intranet or the Internet, to perform the functions as described herein. Such systems, devices, and processors (as described herein) are examples and other systems, devices, and processors may comprise the aforementioned memory storage and processing unit, consistent with embodiments of the invention.

With reference to FIG. 7, FIG. 7 illustrates a computing device 700 in which the present disclosure may be performed. The computing device 700 may include at least one processing unit 702 and system memory 704. The system memory 704 may comprise, but is not limited to, volatile (e.g. random access memory (RAM)), non-volatile (e.g. read-only memory (ROM)), flash memory, or any combination. System memory 704 may include operating system 705, one or more programming modules 706, and may include an input module 102, a calibration module 104, a scaling module 106, and a display module 108, wherein the input module 102, a calibration module 104, a scaling module 106, and a display module 108 are software applications having sufficient computer-executable instructions, which when executed, perform functionalities as described herein. For example, one or more operations of the method 600 as illustrated in FIG. 6 may be performed by these modules.

Operating system 705 may be suitable for controlling the computing device's 700 operation. Furthermore, embodiments of the invention may be practiced in conjunction with a graphics library, other operating systems, or any other application program and is not limited to any particular application or system. This basic configuration is illustrated in FIG. 7 by those components within a dashed line 708. Computing device 700 may also include one or more input device(s) 712 (keyboard, mouse, pen, touch input device, etc.) and one or more output device(s) 714 (e.g., display, speakers, a printer, etc.).

The computing device 700 may include one or more communication connections 716. Communication connections allow computing device 700 to communicate with other computing devices 718. Wireless transmitters and receivers; RF transmitter, receiver, and/or transceiver circuitry; universal serial bus (USB), parallel, and/or serial ports are non-limiting examples of suitable communication connections 716.

The term computer storage media includes volatile and nonvolatile, removable and non-removable media implemented in any method or technology for storage of information, such as computer readable instructions, data structures, or program modules. The system memory 704, the removable storage device 709, and the non-removable storage device 710 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700.

Although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

The computing device 700 may also include additional data storage devices (removable and/or non-removable) such as, for example, magnetic disks, optical disks, or tape. Such additional storage is illustrated in FIG. 7 by a removable storage 709 and a non-removable storage 710. Computing device 700 may also contain a communication connection 716 that may allow device 700 to communicate with other computing devices 718, such as over a network 104 in a distributed computing environment, for example, an intranet or the Internet. Communication connection 716 is one example of communication media.

Program modules, such as the input module 102, a calibration module 104, a scaling module 106, and a display module 108, may include routines, programs, components, data structures, and other types of structures that may perform particular tasks or that may implement particular data types. Moreover, embodiments of the invention may be practiced with other computer system configurations, including hand-held devices, multiprocessor systems, microprocessor-based or programmable user electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

Embodiments of the present invention, for example, are described above with reference to block diagrams and/or operational illustrations of methods, systems, and computer program products according to embodiments of the invention. For example, FIGS. 1-7 and the described functions taking place with respect to each illustration may be considered steps in a process routine performed by one or more local or distributed computing systems. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

It will be clear that the systems and methods described herein are well adapted to attain the ends and advantages mentioned as well as those inherent therein. Those skilled in the art will recognize that the methods and systems within this specification may be implemented in many manners and as such is not to be limited by the foregoing exemplified embodiments and examples. In other words, functional elements being performed by a single or multiple components and individual functions can be distributed among different components. In this regard, any number of the features of the different embodiments described herein may be combined into one single embodiment and alternate embodiments having fewer than or more than all of the features herein described as possible.

While various embodiments have been described for purposes of this disclosure, various changes and modifications may be made which are well within the scope of the disclosed methods. Numerous other changes may be made which will readily suggest themselves to those skilled in the art and which are encompassed in the spirit of the disclosure.

What is claimed:

1. A computer implemented method for displaying a design element on a design space, the method comprising:
receiving a captured image, wherein the captured image includes a calibration object and an environmental object;
identifying the calibration object, wherein the calibration object has at least one identifiable dimension;
calculating a calibration metric, wherein the calculation uses the at least one identifiable dimension of the calibration object;
receiving a virtual image, wherein the virtual image represents a real-world design element;
applying the calibration metric to the virtual image to form a calibrated virtual image;
overlaying the calibrated virtual image onto the captured image to form an overlaid captured image.

2. The method of claim 1, wherein the calibration object represents a real-world item with a displayed vertical dimension representing the real-world item's length and a displayed horizontal dimension representing the real-world item's width, and further wherein the calibration metric is calculated by dividing the displayed horizontal dimension of the calibration object by the width of the real world element.

3. The method of claim 2, wherein the calibration object is identified based on pre-defined characteristic of the real-world element.

4. The method of claim 2, wherein the calibration object has at least two identifiable dimensions and the calculation uses the at least two identifiable dimensions to calculate the calibration metric by dividing the displayed vertical dimension of the calibration object by the length of the real world element to ascertain a vertical calibration metric and dividing the displayed horizontal dimension of the calibration object by the width of the real world element to ascertain a horizontal calibration metric, and further wherein the vertical calibration metric is applied to a vertical dimension of the virtual image and the horizontal calibration metric is applied to a horizontal dimension of the virtual image to form a calibrated virtual image.

5. The method of claim 1, wherein the calibration object is identified by a user outlining the calibration object on the captured image.

6. The method of claim 1, wherein the at least one identifiable dimension of the calibration object represents a real world measurement that is input by a user.

7. The method of claim 1, further comprising receiving input to change properties of the calibrated virtual image.

8. The method of claim 1, further comprising:
receiving a template map; and
arranging the calibrated virtual image in accordance with the template map.

9. The method of claim 4, further comprising receiving input to change the properties of the template map.

10. The method of claim 1, wherein the design element is selected from the group consisting of:
a photograph, a ceramic tile, and a painting.

11. A computer-readable storage device, the computer-readable device storing computer-executable instructions for performing a method of exchanging information in a collaborative networked environment, the method comprising:
receiving, a captured image, wherein the captured image includes a calibration object;
identifying the calibration object, wherein the calibration object has at least one identifiable dimension;
calculating a calibration metric, wherein the calculation uses the at least one identifiable dimension of the calibration object;
receiving a template map;
receiving a virtual image, wherein the virtual image represents a real-world design element;
applying the calibration metric to the virtual image to form a calibrated virtual image;
arranging the calibrated virtual image in accordance with the template map;
overlaying the calibrated virtual image onto the captured image to form an overlaid captured image; and
displaying the overlaid captured image.

12. The computer-readable storage device of claim 8, wherein the calibration object represents a rectangle having length and width measurements corresponding to displayed vertical and horizontal dimensions of the calibration object, and further wherein the calibration metric is determined by dividing a displayed vertical dimension of the calibration object by the length measurement of the rectangle.

13. The computer-readable storage device of claim 12, wherein the calibration object has at least two identifiable dimensions and the calculation uses the at least two identifiable dimensions to calculate the calibration metric by dividing the displayed vertical dimension of the calibration object by the length of the real world element to ascertain a vertical calibration metric and dividing the displayed horizontal dimension of the calibration object by the width of the real world element to ascertain a horizontal calibration metric, and further wherein the vertical calibration metric is applied to a vertical dimension of the virtual image and the horizontal calibration metric is applied to a horizontal dimension of the virtual image to form a calibrated virtual image.

14. The computer-readable storage device of claim 11, further comprising sending information related to the overlaid captured image, where in the information related to the overlaid captured image includes the calibrated virtual image.

15. A system for displaying a design element on a design space, the system comprising:
an input module, wherein the input module receives a captured image and identifies a calibration object within the captured image;
a calibration module, wherein the calibration module calibrates one or more virtual images for overlay on the captured image, and further wherein the calibration module uses the calibration object to calculate a calibration metric;
a template module, wherein the template module maps the one or more virtual images into a template map; and
a display module, wherein the display module displays a calibrated virtual image onto a captured image to form an overlaid image, the calibrated virtual image having been created by calibrating the size of a virtual image using the calibration metric.

16. The system of claim 15, wherein the input module comprises a camera.

17. The system of claim 15, further comprising a purchasing module, wherein the purchasing module allows a user to purchase the calibrated virtual image.

18. The system of claim 15, wherein the calibration object represents an L×W piece of paper oriented in such a way that the L side runs vertically, and the W runs horizontally, and further wherein the calibration metric is determined by dividing a displayed vertical dimension of the calibration object by L.

19. The system of claim 15, wherein the display module shares the overlaid captured image through a network.

20. The system of claim 15, where in the input module, the calibration module, and the display module are instantiated on a mobile device.
